(19) United States
(12) Patent Application Publication
(10) Pub. No.: US 2023/0141243 A1
(43) Pub. Date: May 11, 2023

(54) METHOD AND SYSTEM FOR DELIVERY ITEM USING TAXI

(71) Applicants: HYUNDAI MOTOR COMPANY, Seoul (KR); Kia Corporation, Seoul (KR)

(72) Inventor: Nahyeon PAK, Anyang-si (KR)

(73) Assignees: HYUNDAI MOTOR COMPANY, Seoul (KR); Kia Corporation, Seoul (KR)

(21) Appl. No.: 17/980,936

(22) Filed: Nov. 4, 2022

(30) Foreign Application Priority Data
Nov. 8, 2021 (KR) 10-2021-0151999

(51) Int. Cl. G06Q 10/08; G06Q 50/30

(52) U.S. Cl. CPC G06Q 10/08345; G06Q 50/30

(57) ABSTRACT

A server and a method for providing a delivery service of an item using a vehicle through steps of determining at least one available vehicle to deliver the item from among a plurality of vehicles and an estimated cost corresponding to the at least one available vehicle; transmitting a list of the at least one available vehicle and the estimated cost to a requesting terminal; transmitting delivery information of the item to a shipping vehicle selected by the requesting terminal among the at least one available vehicle; and determining a final cost corresponding to the estimated cost and transmitting a payment completion message of the final cost to the requesting terminal after the item are delivered by the shipping vehicle are provided.

### CROSS-REFERENCE TO RELATED APPLICATION

This application claims priority to and the benefit of Korean Patent Application No. 10-2021-0151999 filed in the Korean Intellectual Property Office on Nov. 8, 2021, the entire contents of which are incorporated herein by reference.

### TECHNICAL FIELD

This description relates to a method and an apparatus for delivery an item using a taxi.

### BACKGROUND

As non-face-to-face services spread and become common, the demand for delivery is increasing. However, due to infrastructure limitations such as lack of manpower and transportation means/distance, the work load of logistics drivers is overloaded, and accidents are increasing accordingly.

In response to this, it is necessary to recruit a large number of manpower to meet the high demand for delivery, and various types of delivery methods such as delivery on foot and delivery by bicycle are also emerging, limited to short distances.

The above information disclosed in this Background section is only for enhancement of understanding of the background of the disclosure, and therefore it may contain information that does not form the prior art that is already known in this country to a person of ordinary skill in the art.

### SUMMARY

Embodiments provides a method for delivering an item using a vehicle.

Embodiments provides a servicer for delivering an item using a vehicle.

According to an embodiment, a method for delivering an item using a vehicle is provided. In such an embodiment, the method includes: determining at least one available vehicle to deliver the item from among a plurality of vehicles and an estimated cost corresponding to the at least one available vehicle; transmitting a list of the at least one available vehicle and the estimated cost to a requesting terminal; transmitting delivery information of the item to a shipping vehicle selected by the requesting terminal among the at least one available vehicle; determining a final cost corresponding to the estimated cost and transmitting a payment completion message for the final cost to the requesting terminal after the item are delivered by the shipping vehicle; and distributing a shipping fee out of the final cost to an owner of the shipping vehicle.

In an embodiment, a first estimated cost corresponding to an available vehicle on which a passenger is boarding or scheduled to board may be more expensive than a second estimated cost corresponding to an available vehicle with no passenger.

In an embodiment, the first estimated cost may be greater by an amount of reward to be paid to the passenger than the second estimated cost.

In an embodiment, the reward may be determined at a disembarkation of the passenger based on an actual arrival delay due to the delivery of the item.

In an embodiment, the determining at least one available vehicle to deliver the item from among a plurality of vehicles and an estimated cost corresponding to the at least one available vehicle may include: offering expected reward to the passenger and querying whether or not to allow the delivery of the item when a predicted transport route of the passenger who has boarded or will board the vehicle is included in the entire or part of a predicted delivery route of the item or is similar to the entire or the part of the predicted delivery route; and determining the estimated cost including the expected reward after the passenger approves the delivery of the item.

In an embodiment, the expected reward may be determined based on a predicted arrival delay due to the delivery of the item.

In an embodiment, a client having the requesting terminal may be an occupant or owner of the item, or a seller or sales intermediary of the item.

In an embodiment, the determining at least one available vehicle to deliver the item from among a plurality of vehicles and an estimated cost corresponding to the at least one available vehicle may include determining the at least one available vehicle among vehicles either located near a delivery origin of the item or directed toward the delivery origin.

In an embodiment, the determining the at least one available vehicle among vehicles either located near a delivery origin of the item or directed toward the delivery origin may include: predicting routes of the vehicles either located near a delivery origin of the item or directed toward the delivery origin based on information related to passenger transportation of the vehicles; and determining the at least one available vehicle based on overlaps of the predicted route of the vehicles and a predicted delivery route of the item.

In an embodiment, the information related to passenger transportation may include at least one of business hours of the vehicles, an operation history of the vehicles, a current operating area of the vehicles, and a popular call area.

According to another embodiment, a server for providing a delivery service of an item using a vehicle is provided. In such an embodiment, the server includes: a processor, a memory, and a communication device, wherein the processor executes a program stored in the memory to perform: determining at least one available vehicle to deliver the item from among a plurality of vehicles and an estimated cost corresponding to the at least one available vehicle; transmitting a list of the at least one available vehicle and the estimated cost to a requesting terminal through the communication device; transmitting delivery information of the item to a shipping vehicle selected by the requesting terminal from among the at least one available vehicle through the communication device; and determining a final cost corresponding to the estimated cost and transmitting a payment completion message of the final cost to the requesting terminal after the item are delivered by the shipping vehicle.

In an embodiment, a first estimated cost corresponding to an available vehicle on which a passenger is on board or scheduled to board may be greater than a second estimated cost corresponding to an available vehicle with no passenger.

In an embodiment, the first estimated cost may be greater by an amount of reward to be paid to the passenger than the second estimated cost.

In an embodiment, the reward may be determined at a disembarkation of the passenger based on an actual arrival delay due to the delivery of the item.

In an embodiment, when the processor performs the determining at least one available vehicle to deliver the item from among a plurality of vehicles and an estimated cost corresponding to the at least one available vehicle, the processor may perform: offering expected reward to the passenger and querying whether or not to allow the delivery of the item when a predicted transport route of the passenger who has boarded or will board the vehicle is included in the entire or part of a predicted delivery route of the item or is similar to the entire or the part of the predicted delivery route; and determining the estimated cost including the expected reward after the passenger approves the delivery of the item.

In an embodiment, the expected reward may be determined based on a predicted arrival delay due to the delivery of the item.

In an embodiment, a client having the requesting terminal may be an occupant or owner of the item, or a seller or sales intermediary of the item.

In an embodiment, when the processor performs the determining at least one available vehicle to deliver the item from among a plurality of vehicles and an estimated cost corresponding to the at least one available vehicle, the processor may perform determining the at least one available vehicle among vehicles either located near a delivery origin of the item or directed toward the delivery origin.

In an embodiment, when the processor performs the determining the at least one available vehicle among vehicles either located near a delivery origin of the item or directed toward the delivery origin, the processor may perform: predicting routes of the vehicles either located near a delivery origin of the item or directed toward the delivery origin based on information related to passenger transportation of the vehicles; and determining the at least one available vehicle based on overlaps of the predicted route of the vehicles and a predicted delivery route of the item.

In an embodiment, the information related to passenger transportation may include at least one of business hours of the vehicles, an operation history of the vehicles, a current operating area of the vehicles, and a popular call area.

In an embodiment, the processor may execute the program to further perform distributing a shipping fee out of the final cost to an owner of the shipping vehicle.

### BRIEF DESCRIPTION OF THE DRAWINGS

FIG. 1 is a schematic diagram illustrating a delivery system of an item using a taxi according to an embodiment.

FIG. 2 is a flowchart illustrating a method for delivering an item using a taxi according to an embodiment.

FIG. 3 is a block diagram illustrating a service-providing server according to an embodiment.

### DETAILED DESCRIPTION OF THE EMBODIMENTS

In the following detailed description, only certain embodiments of the present disclosure have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a terminal may be called user equipment (UE), mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

In this specification, unless explicitly described to the contrary, the word “comprises”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

As used herein, “A or B”, “at least one of A and B”, “at least one of A or B”, “A, B, or C”, “at least one of A, B, and C”, and “at least one of A, B, or C” each may include any one of, or all possible combinations of, items listed together in the corresponding one of the phrases.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

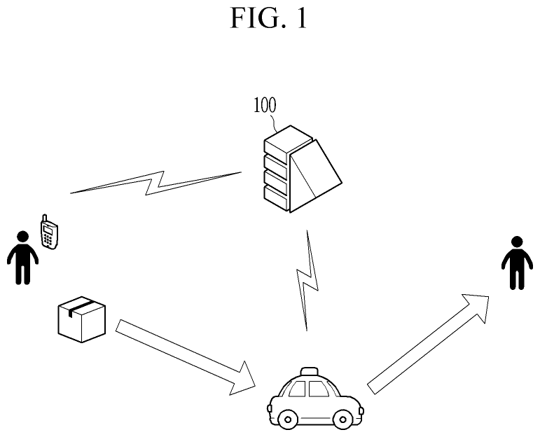

FIG. 1 is a schematic diagram illustrating a delivery system of an item using a taxi according to an embodiment.

Referring to FIG. 1, a delivery system according to an embodiment may include a requesting terminal, a service-providing server 100, and a shipping vehicle.

The requesting terminal may request delivery of the item (including an object, an article, stuff, a stock, and/or food) for the service-providing server 100. A client having the requesting terminal, as a subject requesting the delivery of the item, may be an occupant or owner of the item, or may be a natural or legal person who sells the item or mediates the sale of the item. When the client, for example, is the seller of the item in such an open market, the seller may designate a logistics center or a fulfillment logistics center of the seller as a delivery origin of the item. The requesting terminal may determine the shipping vehicle from a list of available vehicles provided by the service-providing server 100.

The service-providing server 100 according to an embodiment may provide a delivery service to the requesting terminal by processing the delivery request received from the requesting terminal through the shipping vehicle. The service-providing server 100 according to an embodiment may determine an available vehicle in consideration of delivery information included in the delivery request of the requesting terminal and a predicted route of vehicles near the delivery origin of the item, and determine an estimated cost corresponding to each available vehicle. After the delivery of the item is completed by the shipping vehicle determined by the requesting terminal among the vehicles included in the list of the available vehicles, the service-providing server 100 may process the final cost according to the delivery service and notify the requesting terminal of the processed final cost.

The shipping vehicle may be a vehicle determined by the requesting terminal from among the available vehicles determined by the service-providing server 100. A passenger may be on board or there may not be a passenger in the shipping vehicle, and the shipping vehicle may be a vehicle returning from work or a vehicle waiting in a garage. The shipping vehicle (e.g., taxi) of the present description may include any type of passenger transport vehicle that transports passengers to a destination, and may include a manned taxi with a driver and an unmanned taxi or autonomous vehicle without the driver.

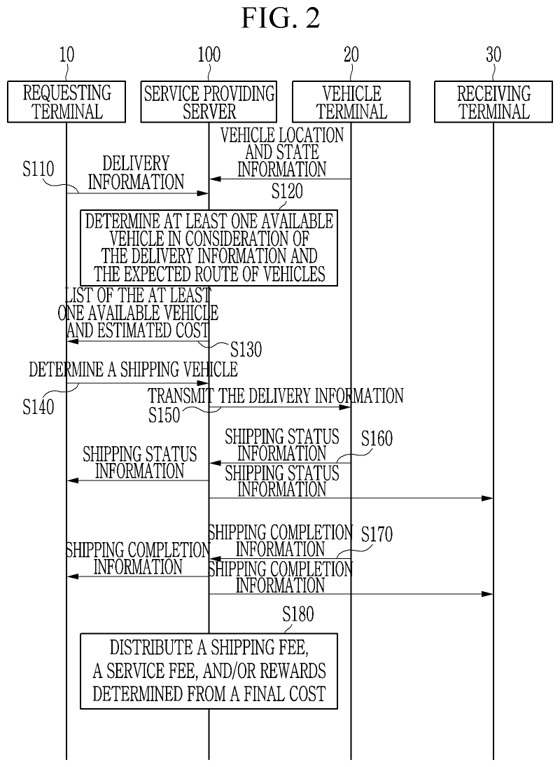

FIG. 2 is a flowchart illustrating a method for delivering an item using a taxi according to an embodiment.

Referring to FIG. 2, a service-providing server 100 may receive delivery information of an item (including an object, an article, stuff, a stock, and/or food) from a requesting terminal 10 (S110) and determine a vehicle available for the delivery based on the delivery information of the thing received from the requesting terminal 10 and a predicted route of the available vehicle (S120).

The delivery information of the item may include information about a delivery origin and delivery destination, a type, size, weight, and the like of the item. The service-providing server 100 may determine a delivery fee and service fee based on a route between the origin and the destination of the item and the type, size, and weight of the item.

The service-providing server 100 may determine a predicted route of a vehicle based on the vehicle location and information of vehicle state received from the vehicle terminal 20. An empty vehicle in which a passenger is not on-board may include a vehicle waiting in the platform or a garage and a vehicle wandering in the business area. In the present description, the vehicle on which the passenger is boarded or is scheduled to be boarded is referred to as a vehicle with a passenger, and the vehicle that is roaming to pick up the passenger, that is, the vehicle that the passenger is not currently on and has no reservations for boarding, is referred to as a vehicle without a passenger.

The service-providing server 100 may generate information related to passenger transportation including the vehicle location and vehicle state received from the vehicle terminal 20 and manage the generated information related to passenger transportation. The information related to passenger transportation may include business/non-business hours of the vehicle, operation history of the vehicle, current operation area of the vehicle, and popular call areas by time period, and the service-providing server 100 may predict the route of the vehicle based on the information related to passenger transportation.

In the case of an empty vehicle, the service-providing server 100 may predict the route of the vehicle based on the platform location, the operation area of the driver of the vehicle, and the operation history. Alternatively, the service-providing server 100 may determine the predicted transportation route for the vehicle on which the passenger is boarded, based on the destination of the passenger.

The service-providing server 100 may determine at least one available vehicle for the delivery among the plurality of vehicles located near the delivery origin of the item or directed toward the delivery origin or near the delivery origin. The service-providing server 100, to determine the at least one available vehicle for the delivery, may predict the route of the vehicles that are located near the delivery origin of the item or goes to the delivery origin or near the delivery origin and determine the at least one available vehicle based on the overlaps between predicted transport route of the vehicles and predicted delivery routes of the item.

The service-providing server 100 may determine that the estimated cost corresponding to an available vehicle on which a passenger is on board or scheduled to be boarded is greater (that is, more expensive) than the estimated cost corresponding to an empty available vehicle. In this case, the difference between the two estimated costs may be due to the amount of reward (or expected reward) to be paid to the passenger. That is, the estimated cost corresponding to the available vehicle on which the passenger is boarding or scheduled to board may be greater than the estimated cost corresponding to the available vehicle that is empty by the amount of the reward to be paid to the passenger. The reward may be the value provided because the passenger has approved the delivery of the item and may be determined based on a predicted arrival delay due to the delivery of the item. The reward may be paid to the passenger in various forms such as cash, points, and reserves. Alternatively, at the request of the passenger, the taxi fare may be discounted by the amount of reward.

The service-providing server 100 may query the passenger whether to allow the delivery of the item before determining that the vehicle on which the passenger is boarding or is scheduled to be boarded is available. For example, the service-providing server 100 may query whether or not to allow delivery of the item when the predicted transport route of the passenger who has boarded or will board the vehicle is included in the entire or part of the predicted delivery route of the item or is similar to the entire or part of the predicted delivery route.

At this time, the service-providing server 100 may offer the expected reward while querying whether or not to allow the delivery of the item, and passenger may allow or reject the delivery of the item by considering factors such as the amount of the expected reward and the arrival delay due to the delivery of the item.

The expected reward may be predetermined by the service-providing server 100 based on the predicted arrival delay due to the delivery of the item. In addition, the expected reward may be changed according to the actual arrival delay determined at the time of disembarkation of the passenger, and the passenger may receive the changed final reward after the disembarkation. That is, the final reward may be determined according to the actual arrival delay. The rewards may be provided to the passenger in various forms, such as cash, points, reserve points, and fare discounts.

Referring to FIG. 2, the service-providing server 100 may transmit a list of the available vehicles and the estimated cost corresponding to each available vehicle to the requesting terminal 10 (S130). When the passenger, who is boarding the vehicle or is scheduled to board, approves the delivery of the item, the service-providing server 100 may match the estimated cost including the expected reward presented to the passenger with the available vehicle and deliver the estimated cost to the requesting terminal 10. The list of vehicles available for the delivery may be provided sequentially to the requesting terminal with a low estimated cost or may be provided sequentially with a fast delivery time. Alternatively, the list of the available vehicles may be sequentially provided to the requesting terminal in an order of overlaps between the predicted route of the vehicle and the predicted delivery route of the item.

The estimated cost may include delivery fees and service fees. When the passenger is on board in an available vehicle or will be boarding soon (e.g., a vehicle heading from a taxi call service to a call point, i.e. a vehicle with a passenger), the estimated cost may include the expected reward to be provided to the passenger. The delivery fee may be distributed to the driver of the vehicle and the service fee may be distributed to the operator of the service-providing server 100. Thereafter, the requesting terminal 10 may notify the shipping vehicle selected by the requesting terminal to the service-providing server 100 (S140), the service-providing server 100 may transmit the delivery information of the item to the vehicle terminal 20 of the selected shipping vehicle (S150).

Before the delivery information of the item is transmitted to the shipping vehicle, the service-providing server 100 may query whether to accept the delivery of the item by sending a request for delivery of the item to the driver of the vehicle. After the driver of the vehicle accepts the delivery of the item, the service-providing server 100 may transmit the delivery information of the item to the vehicle terminal 20 of the shipping vehicle.

If the drive of the vehicle has set up automatic acceptance of the delivery request, the vehicle without a passenger may be directly determined as the shipping vehicle. Since the driver of the vehicle during non-business hours when the passenger is not on board may have trouble deciding to accept each time a delivery request comes, the automatic acceptance of the delivery request may be set. When the automatic acceptance is preset, the driver of the vehicle during non-business hours may move the vehicle according to the delivery information of the item. Even if the delivery request is accepted because the automatic acceptance is set, the driver of the vehicle may cancel the acceptance of the delivery request according to the vehicle's route or personal choice. When the acceptance of the delivery request is canceled, the service-providing server 100 may notify the requesting terminal 10 that acceptance of the delivery request has been canceled or may request reselection of the delivery vehicle.

The vehicle terminal 20 of the shipping vehicle may report the shipping status information of the item to the service-providing server 100, and the service-providing server 100 may transmit the shipping status information to the requesting terminal 10 (S160). Also, the service-providing server 100 may transmit the shipping status information to the receiving terminal 30 when the receiving terminal 30 is connected to the service-providing server 100. The shipping status information provided to the receiving terminal 30 may include the expected arrival time of the item, driver information of the vehicle, the current location of the vehicle, and the like. In an embodiment, as the current location of the vehicle is changed, the arrival schedule of the item may also be changed.

When the receiving terminal 30 is connected to the service-providing server 100, the service-providing server 100 may query the receiving terminal 30 for the form of receipt of the item. For example, the service-providing server 100 may query whether the item are directly received, whether the receiving location is changed, and the like. When the receiving terminal selects to receive the item directly, the service-providing server 100 may transmit a receiving time and place to the receiving terminal 30. In addition, the service-providing server 100 may inform the receiving terminal 30 of a penalty, etc. when a waiting time for receipt is exceeded.

After the vehicle terminal 20 of the shipping vehicle delivers the item to the client of the receiving terminal, the vehicle terminal 20 may report the delivery completion information to the service-providing server 100. The service-providing server 100 may transmit the delivery completion information to the requesting terminal 10 (S170). The above functions of the service-providing server 100 may be provided by the logistics server of the logistics center, and the service-providing server 100 may simultaneously perform the functions of the logistics server.

When the delivery of the item is completed, the service-providing server 100 may determine a final cost, and transmit payment completion message of the final cost to the requesting terminal 10. The service-providing server 100 may distribute a shipping fee, a service fee, and/or a reward from the final paid cost (S180).

As described above, the service-providing server according to an embodiment can contribute significantly to the reduction of the logistics burden by providing the delivery service of items by utilizing a vehicle for passenger transport.

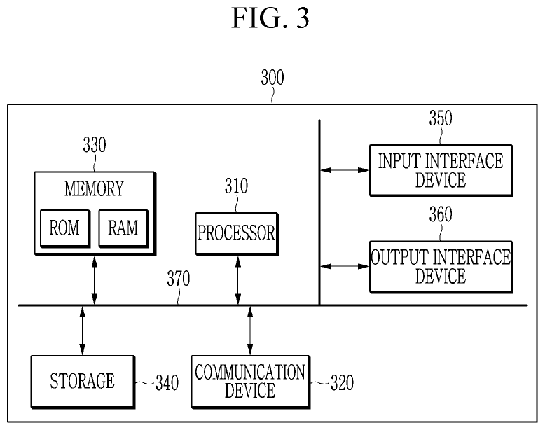

FIG. 3 is a block diagram illustrating a service-providing server according to an embodiment.

The service-providing server according to an embodiment may be implemented as a computer system, for example, a computer-readable medium. Referring to FIG. 3, the computer system 300 may include at least one of a processor 310, a memory 330, an input interface device 350, an output interface device 360, and a storage device 340 communicating through a bus 370. The computer system 300 may also include a communication device 320 coupled to the network. The processor 310 may be a central processing unit (CPU) or a semiconductor device that executes instructions stored in the memory 330 or the storage device 340. The memory 330 and the storage device 340 may include various forms of volatile or nonvolatile storage media. For example, the memory may include read only memory (ROM) or random-access memory (RAM). In the embodiment of the present disclosure, the memory may be located inside or outside the processor, and the memory may be coupled to the processor through various means already known. The memory is a volatile or nonvolatile storage medium of various types, for example, the memory may include read-only memory (ROM) or random-access memory (RAM).

According to an exemplary embodiment of the present disclosure, the computer system 300 may include a processor (e.g., computer, microprocessor, CPU, ASIC, circuitry, logic circuits, etc.) and an associated non-transitory memory storing software instructions which, when executed by the processor, provides the functionalities of the processor 310, the communication device 320, the input interface device 350 and the output interface device 360. Herein, the memory and the processor may be implemented as separate semiconductor circuits. Alternatively, the memory and the processor may be implemented as a single integrated semiconductor circuit. The processor may embody one or more processor(s).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 320 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD—ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any disclosure or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above—described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A method for delivering an item using a vehicle, the method comprising:
determining at least one available vehicle to deliver the item from among a plurality of vehicles and an estimated cost corresponding to the at least one available vehicle;
transmitting a list of the at least one available vehicle and the estimated cost to a requesting terminal;
transmitting delivery information of the item to a shipping vehicle selected by the requesting terminal among the at least one available vehicle;
determining a final cost corresponding to the estimated cost and transmitting a payment completion message for the final cost to the requesting terminal after the item are delivered by the shipping vehicle; and
distributing a shipping fee out of the final cost to an owner of the shipping vehicle.

2. The method of claim 1, wherein:
a first estimated cost corresponding to an available vehicle on which a passenger is boarding or scheduled to board is more expensive than a second estimated cost corresponding to an available vehicle with no passenger.

3. The method of claim 2, wherein:
the first estimated cost is greater by an amount of reward to be paid to the passenger than the second estimated cost.

4. The method of claim 3, wherein:
the reward is determined at a disembarkation of the passenger based on an actual arrival delay due to the delivery of the item.

5. The method of claim 1, wherein:
the determining at least one available vehicle to deliver the item from among a plurality of vehicles and an estimated cost corresponding to the at least one available vehicle comprises:
offering expected reward to the passenger and querying whether or not to allow the delivery of the item when a predicted transport route of the passenger who has boarded or will board the vehicle is included in the entire or part of a predicted delivery route of the item or is similar to the entire or the part of the predicted delivery route; and
determining the estimated cost including the expected reward after the passenger approves the delivery of the item.

6. The method of claim 5, wherein:
the expected reward is determined based on a predicted arrival delay due to the delivery of the item.

7. The method of claim 1, wherein:
the determining at least one available vehicle to deliver the item from among a plurality of vehicles and an estimated cost corresponding to the at least one available vehicle comprises
determining the at least one available vehicle among vehicles either located near a delivery origin of the item or directed toward the delivery origin.

8. The method of claim 7, wherein:
the determining the at least one available vehicle among vehicles either located near a delivery origin of the item or directed toward the delivery origin comprises:
predicting routes of the vehicles either located near a delivery origin of the item or directed toward the delivery origin based on information related to passenger transportation of the vehicles; and
determining the at least one available vehicle based on overlaps of the predicted route of the vehicles and a predicted delivery route of the item.

9. The method of claim 8, wherein:
the information related to passenger transportation includes at least one of business hours of the vehicles, an operation history of the vehicles, a current operating area of the vehicles, and a popular call area.

10. A server for providing a delivery service of an item using a vehicle, the server comprising:
a processor, a memory, and a communication device, wherein the processor executes a program stored in the memory to perform:
determining at least one available vehicle to deliver the item from among a plurality of vehicles and an estimated cost corresponding to the at least one available vehicle;
transmitting a list of the at least one available vehicle and the estimated cost to a requesting terminal through the communication device;
transmitting delivery information of the item to a shipping vehicle selected by the requesting terminal from among the at least one available vehicle through the communication device; and
determining a final cost corresponding to the estimated cost and transmitting a payment completion message of the final cost to the requesting terminal after the item are delivered by the shipping vehicle.

11. The server of claim 10, wherein:
a first estimated cost corresponding to an available vehicle on which a passenger is on board or scheduled to board is greater than a second estimated cost corresponding to an available vehicle with no passenger.

12. The server of claim 11, wherein:
the first estimated cost is greater by an amount of reward to be paid to the passenger than the second estimated cost.

13. The server of claim 12, wherein:
the reward is determined at a disembarkation of the passenger based on an actual arrival delay due to the delivery of the item.

14. The server of claim 10, wherein:
when the processor performs the determining at least one available vehicle to deliver the item from among a plurality of vehicles and an estimated cost corresponding to the at least one available vehicle, the processor performs:
offering expected reward to the passenger and querying whether or not to allow the delivery of the item when a predicted transport route of the passenger who has boarded or will board the vehicle is included in the entire or part of a predicted delivery route of the item or is similar to the entire or the part of the predicted delivery route; and
determining the estimated cost including the expected reward after the passenger approves the delivery of the item.

15. The server of claim 14, wherein:
the expected reward is determined based on a predicted arrival delay due to the delivery of the item.

16. The server of claim 10, wherein:
when the processor performs the determining at least one available vehicle to deliver the item from among a plurality of vehicles and an estimated cost corresponding to the at least one available vehicle, the processor performs
determining the at least one available vehicle among vehicles either located near a delivery origin of the item or directed toward the delivery origin.

17. The server of claim 16, wherein:
when the processor performs the determining the at least one available vehicle among vehicles either located near a delivery origin of the item or directed toward the delivery origin, the processor performs:
predicting routes of the vehicles either located near a delivery origin of the item or directed toward the delivery origin based on information related to passenger transportation of the vehicles; and
determining the at least one available vehicle based on overlaps of the predicted route of the vehicles and a predicted delivery route of the item.

18. The server of claim 17, wherein:
the information related to passenger transportation includes at least one of business hours of the vehicles, an operation history of the vehicles, a current operating area of the vehicles, and a popular call area.

19. The server of claim 10, wherein:
the processor executes the program to further perform:
distributing a shipping fee out of the final cost to an owner of the shipping vehicle.
